(19) United States
(12) Patent Application Publication
(10) Pub. No.: US 2015/0019370 A1
(43) Pub. Date: Jan. 15, 2015

(54) Customized Storybooks Related Methods and Interface

(71) Applicant: Jeffrey Steven Ochs, St. Paul, MN (US)

(72) Inventor: Jeffrey Steven Ochs, St. Paul, MN (US)

(21) Appl. No.: 14/318,670

(22) Filed: Jun. 29, 2014

Related U.S. Application Data
(60) Provisional application No. 61/842,016, filed on Jul. 2, 2013.

(51) Int. Cl. G06Q 30/06

(52) U.S. Cl. CPC G06Q 30/0621
USPC 705/26.5

(57) ABSTRACT

A system and methods related customized storybooks and related methods are disclosed. A method can include presenting a list of stories to a plurality of artists, providing the plurality of artists with at least one common design parameter, providing each artist with instructions to submit a version of his/her story, and executing a license agreement with each artist submitting a story version. The method can further include providing a mechanism for each artist submitting a story version to submit and receive feedback. Another method can include allowing a customer to select more than one story from a catalog, allowing the customer to select the order of the more than one story within a single storybook, and allowing the customer to select at least one language for each story selected. The methods may further include allowing the customer to provide variable text information for at least one story selected and/or allowing the customer to customize a cover page or a dedication page of the storybook.

### RELATED APPLICATIONS

This application claims the benefit of U.S. Provisional Application No. 61/842,016 filed 2 Jul. 2013, entitled “Customized Story Books and Related Methods” which is incorporated herein by reference.

### FIELD OF THE INVENTION

The present disclosure pertains to customized storybooks and related methods.

### BACKGROUND

Stories have existed since the beginning of humanity and are present in cultures throughout the world. Stories are central to the human experience. For thousands of years, people the world over have relied on them to educate and to entertain. They define the identities of entire communities, cultures, and religions, and they bind generations together across time. When shared with children, stories not only spark imagination, they “serve to initiate children into aspects of a social heritage, transmitting many of a culture's central values and assumptions and a body of shared allusions and experiences.”[i]

It is because of their cultural significance that society should be concerned with the fact that thousands of traditional fables, parables, and moral stories from cultures all around the world are unillustrated, unavailable in the US book market, and disappearing from memory. The absence of these stories from the private market constitutes what economists call a “market failure.”

There are two main reasons for this market failure. First, what makes traditional fables and parables so special—that they literally belong to all of us—is exactly what undermines the private market's ability to deliver them. These stories are part of the “public domain,” which means that no one owns a copyright in them. As a result, traditional for-profit companies, which profit most when holding exclusive rights to content, avoid investing in them. Ironically, because anyone can publish and print these stories, no one does.

The second reason for this market failure lies in the constraints of the traditional publishing model. Because companies must incur high up-front costs to create quality content, purchase physical inventory, and then take the work to market, they typically select only the most popular stories that already enjoy high demand in the mass market to reduce risk. This means quality fables and parables from lesser known collections or minority cultures are conspicuously absent from our bookstore shelves.

### BRIEF SUMMARY

The present inventors recognize, among other things, that many short stories with moral, historical, cultural, or entertainment value, especially those that are not well known, are not available for customers to purchase in the marketplace. Even when short stories are available for purchase, their formatting and design can be undesirable and a customer lacks control over story content.

A reason for this marketplace failure is that the traditional book publishing model encourages companies to create products that will appeal to big, revenue-producing market sizes. In order to make money, a company typically needs to sell a large volume of mass-produced books. Additionally, companies traditionally pay story artists up front for their work, accepting risk with every story that is illustrated. These factors discourage investment in, and marketing of, less popular stories.

The present customized storybooks and related methods can overcome the limitations of traditional book publishing, particularly in the short story market, by coupling the crowdsourcing of short story writing and illustration to individual artists, and the mass customization of storybooks for individual customers.

### BRIEF DESCRIPTION OF THE DRAWINGS

FIG. 1 illustrates a method of crowdsourcing the writing and illustration of one or more short stories to one or more individual artists, as constructed in accordance with at least one embodiment.

FIG. 2 illustrates a method of mass customization of storybooks for individual customers, as constructed in accordance with at least one embodiment.

FIG. 3 illustrates an exemplary system for practicing a method of crowd sourcing the writing and illustration of short stories to one or more individual artists and/or a method of mass customization of storybooks for individual customers.

FIG. 4 illustrates an exemplary user interface home page, which may be stored on non-transitory computer-readable media and which when executed by a computer processor allows the user to create a custom storybook

FIG. 5 illustrates an exemplary user interface for choosing stories to be included in a custom storybook.

FIG. 6 illustrates the story page with a window showing the stories chosen by the user.

FIG. 7 illustrates a customization page for a custom storybook interface.

FIG. 8 illustrates a dedication page where the customer may write a personalized dedication or note to the recipient of the book

FIG. 9 illustrates choosing a particular language for each of the stories for a customized storybook.

FIG. 10 allows users to personalize the moral of the story with the recipient's name on the “moral dedications” page.

FIG. 11 illustrates an exemplary shopping cart for purchasing a customized storybook.

### DETAILED DESCRIPTION

Methods of creating customized storybooks may relate to the creation of the story and its illustration or creation of a compilation of stories of interest to a customer.

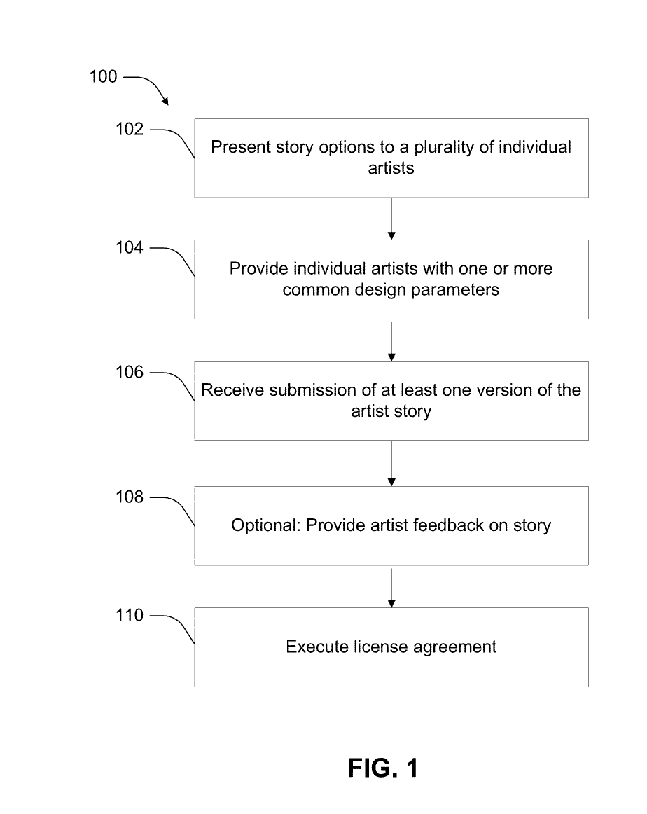

FIG. 1 illustrates a method 100 of crowdsourcing the writing and illustration of one or more short stories to one or more individual artists. The method can include, at 102, presenting a list of stories which are stored in a database, to a group of individual artists. The stories can be pre-approved stories and can include stories already in the public domain or original stories that have been voluntarily submitted by an author for retelling and illustration. Presentation of the list of stories can be accomplished electronically, such as through use of the Internet, and to a group of at least five individuals artists or at least ten individual artists.

At 104, the method can include providing the individual artists with one or more common design parameters. The common design parameters can help provide consistency in illustration format for each story. The common design parameters can include, by way of example, a set number of pages per story, a set size for an image, a locked aspect ratio for the image, directions on type of materials to be used, instructions for positioning text within a story, and/or a set target age level for the story.

Each artist can be provided, at 106, with instructions to submit at least one version of his/her story throughout the full design process.

Optionally, at 108, each artist can be provided feedback on at least one version of his/her story.

At 110, a license agreement with an artist can be executed. The license agreement can allow the story to be used for commercial and non-commercial purposes, as articulated in the agreement's text.

It is believed that the method 100 of crowdsourcing the writing and illustration of one or more short stories to one or more individual artists can provide many advantages compared to traditional methods used in the writing and illustrating of short stories. For example, under the traditional method, publishers rely on a small number of famous or well-established authors and illustrators for their content. As a result, emerging artists have a difficult time breaking into the industry and getting published. The method 100 provides an opportunity for a wide variety of stories and styles in order to give customers individually what they want. By crowdsourcing content, the method 100 is able to create a diverse catalog of short stories for customer selection. Under the traditional method, publishers need to accept a lot of risk when they engage an artist to write or illustrate a short story. This results in fewer and less diverse stories. The method 100 provides, by crowdsourcing content, an ability to share the risk and expense of adding new stories to the marketplace catalog with a broad group of individual artists. Additionally, the method 100 allows artists to retain ownership of their stories and license them to a company, making the company's marketplace catalog a more community-owned resource, which has helpful symbolic and practical consequences for crowdsourcing and marketing.

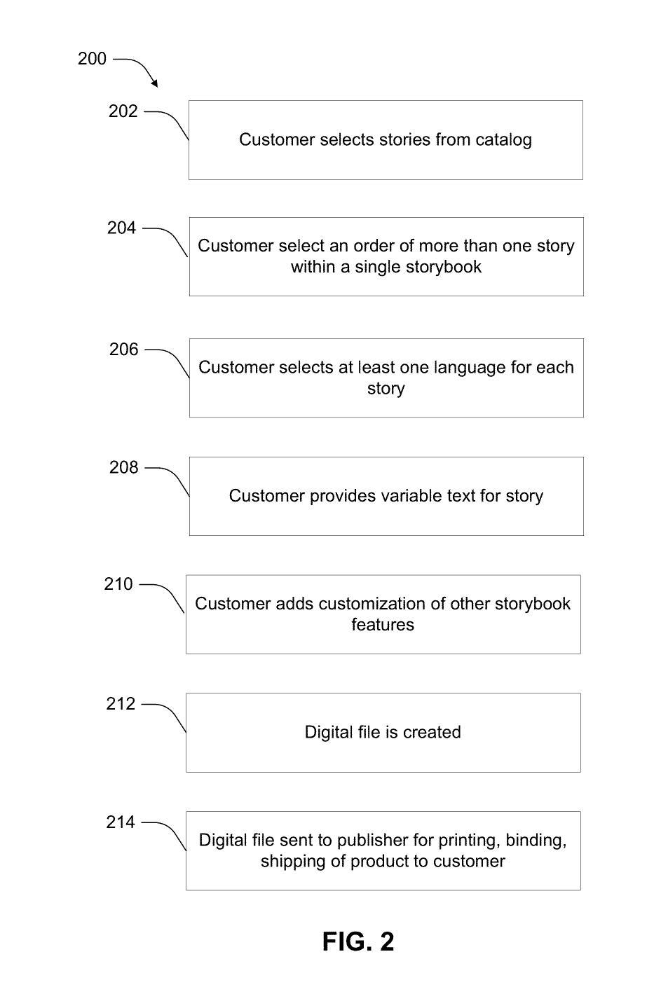

FIG. 2 illustrates a method 200 of mass customization of storybooks for individual customers. The method can include, at 202, allowing a customer to select more than one story, from a catalog with a plurality of short stories, designed with a consistent design parameter. The catalog with the plurality of short stories can be an online, digital, or physical catalog.

At 204, the customer can select an order of the more than one story within the storybook. At 206, the customer can select at least one available language for each story selected. For each story selected, the customer has an option to provide variable text information at 208. In some embodiments, variable text may be entered for a dedication page, cover page or for any other page appropriate for an individual story or customized storybook. At 210 the customer can select to customize other features of the storybook, such as a cover page or a dedication page.

After the completion of one or more of steps 202-210, the customer's unique order information may be incorporated into an original digital file for the customized book, at 212 and communicated, via API or by other means, to a printer for, at 214, the printing, binding, and shipping of the customized book.

It is believed that the method 200 of mass customization of storybooks for individual customers can provide many advantages compared to traditional methods used in selling short stories. For example, under the traditional method, publishers aim to sell large volumes of a small number of stories. The method 200 provides an opportunity to make money by selling customized books to individual customers. Under the traditional method, customers have to accept the storybooks that appealed to the mass market and cannot adapt books to their own tastes and values. Using the method 200, customers can individually tailor books to meet their needs.

The method 200 also provides advantages over existing books having limited personalization in a variety of ways. Existing personalized books limit a customer to one short story per book. The method 200 allows customers to select and incorporate multiple short stories in a single book. Because existing personalized books limit the customer to one short story per book, there is no option for selecting an order of stories within the book. The method 200 allows customers not only to select multiple short stories of interest, but also to select the order in which the stories appear in the book. Further, existing personalized books do not allow the customer to select a unique language for each story. The method 200 allows customers to pick at least one language for each story selected.

In sum, the method 200 is unique in many ways, including its ability to provide customers with variable text personalization in combination with other personalization options such as multiple stories, story order, and language.

In a preferred embodiment of the methods described above of 100, crowdsourcing the writing and illustration of one or more short stories to one or more individual artists and of 200, mass customization of storybooks for individual customers, a system on which to perform the described methods is provided over a network such as the internet. Such a system would involve the use of a number of electronic computing devices connected via the network. Programming code stored in nontransitory computer memory and executed by computer processors provides a specialized set of equipment for performing the methods. Artists and customers may use a browser on an internet-enabled computer to navigate to a web site providing an interface to the system. Artists may view available stories, submit samples of their work and enter into licensing agreements via the interface. Customers may view and select from the product catalog, and add customized text to their product choices, and purchase their selections.

An electronic computing device, such as a server, personal computer, laptop, tablet computer, smart phone, or other mobile computing device is typically comprised of, among other things, a processor (central processing unit, or CPU), memory, input and output devices, a secondary storage device, and possibly a display device, all of which may be interconnected using a system bus. A processor generally comprises two critical components: the logic unit and the control unit. The logic unit performs arithmetic and logic operations. The control unit extracts instructions from memory, decodes and executes them. The memory may include random access memory (RAM) or similar types of memory. Software applications and modules, stored in the memory or secondary storage for execution by a processor are operatively configured to perform the operations in an embodiment of the system. A software application may correspond with a single module or any number of modules. Modules of a computer system may be made from hardware, software, or a combination of the two. Generally, software modules are program code or instructions for controlling a computer processor to perform a particular method to implement the features or operations of the system. The modules may also be implemented using program products or a combination of software and specialized hardware components. In addition, the modules may be executed on multiple processors for processing a large number of transactions, if necessary or desired.

Input and output may be manually performed on sub-components of the computer or device system such as a keyboard or disk drive, but may also be electronic communications between devices connected by a network, such as a wide area network (e.g. the Internet) or a local area network. A secondary storage device may include a hard disk drive, floppy disk drive, CD-ROM drive, DVD-ROM drive, or other types of non-volatile data storage, and may correspond with the various equipment and modules shown in the figures. The processor may execute the software applications or programs either stored in memory or secondary storage or received from the Internet or other network. The input device may include any device for entering information into computer, such as a keyboard, joy-stick, cursor-control device, or touch-screen. The display device may include any type of device for presenting visual information such as, for example, a computer monitor or flat-screen display. The output device may include any type of device for presenting a hard copy of information, such as a printer, and other types of output devices include speakers or any device for providing information in audio form.

Although the computer, computing device or server has been described with various components, it should be noted that such a computer, computing device or server can contain additional or different components and configurations. In addition, although aspects of an implementation consistent with the system disclosed are described as being stored in memory, these aspects can also be stored on or read from other types of computer program products or computer-readable media, such as secondary storage devices, including hard disks, floppy disks, or CD-ROM; a non-transitory carrier wave from the Internet or other network; or other forms of RAM or ROM. Furthermore, it should be recognized that computational resources can be distributed, and computing devices can be client or server computers. Client computers and devices (e.g.) are those used by end users to access information from a server over a network, such as the Internet. These devices can be a desktop or laptop computer, a standalone desktop, or any other type of computing device. Servers are understood to be those computing devices that provide services to other machines, and can be (but are not required to be) dedicated to hosting applications or content to be accessed by any number of client computers. Web servers, application servers and data storage servers may be hosted on the same or different machines. They may be located together or be distributed across locations. Operations may be performed from a single computing device or distributed across geographically or logically diverse locations.

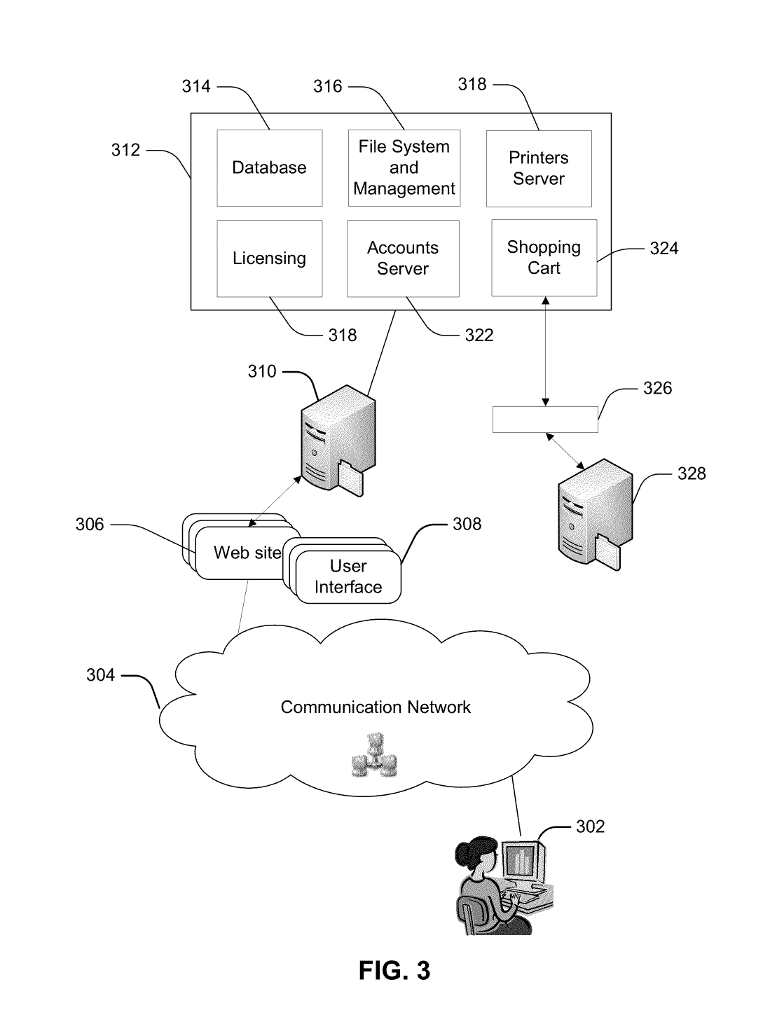

An exemplary embodiment of a system that may deliver the methods described above is illustrated in FIG. 3. On the client side 302, an artist or customer uses a computing device connected to a communication network 304 such as the internet, to access a website 306 with user interface 308. The web site typically is provided on a web server 310 that may store web files, and may additionally store the modules comprising the system 312. Exemplary modules include a database 314, a file system and management module 316, a printers server module 318, a licensing module 320 and an accounts server module 322. These various components of this system are offered by way of example and not limitation. In other words, other configurations and devices may be used to implement the claimed methods without departing from the claimed invention. In addition to these components, a shopping cart 324 is provided for purchasing customized storybooks, along with a communications interface 326 to systems belonging to printing partners 328 who may receive, print, pack and ship the customized storybook.

A system and method for delivering customized storybooks to customers may utilize a user interface 308, comprising executable instructions stored on non-transitory computer-readable media, that when executed by a computer processor provide an environment that allows a user to choose various elements of the storybook and submit an order which will then be transmitted to a printer, published, packaged, and shipped to the customer.

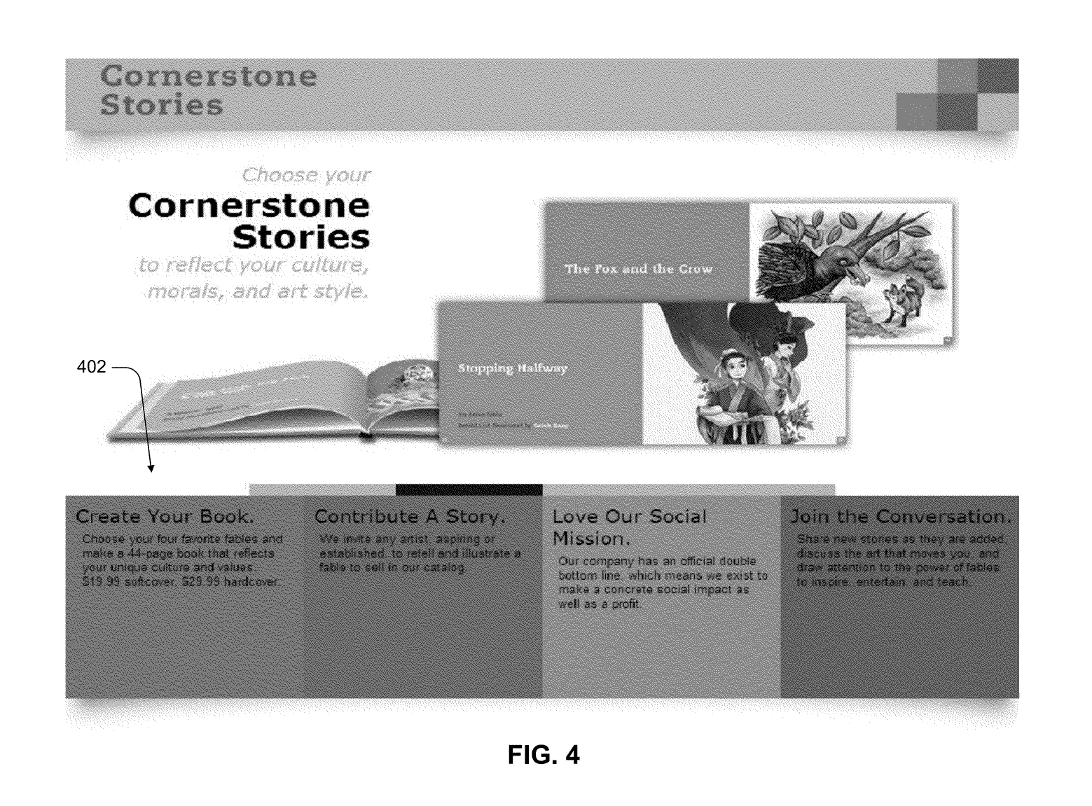

FIG. 4. illustrates an exemplary user interface home page, which may be stored on non-transitory computer-readable media and which when executed by a computer processor allows the user to create a custom storybook. Here, users may select a web site function 402 such as: create a custom storybook, contribute a story, view the company's social mission and share and discuss ideas. One of ordinary skill in the art would recognize that any type of function may be provided along with the ability to create a customized story book and contribute a story. Contributing a story also includes contributing illustrations for a story.

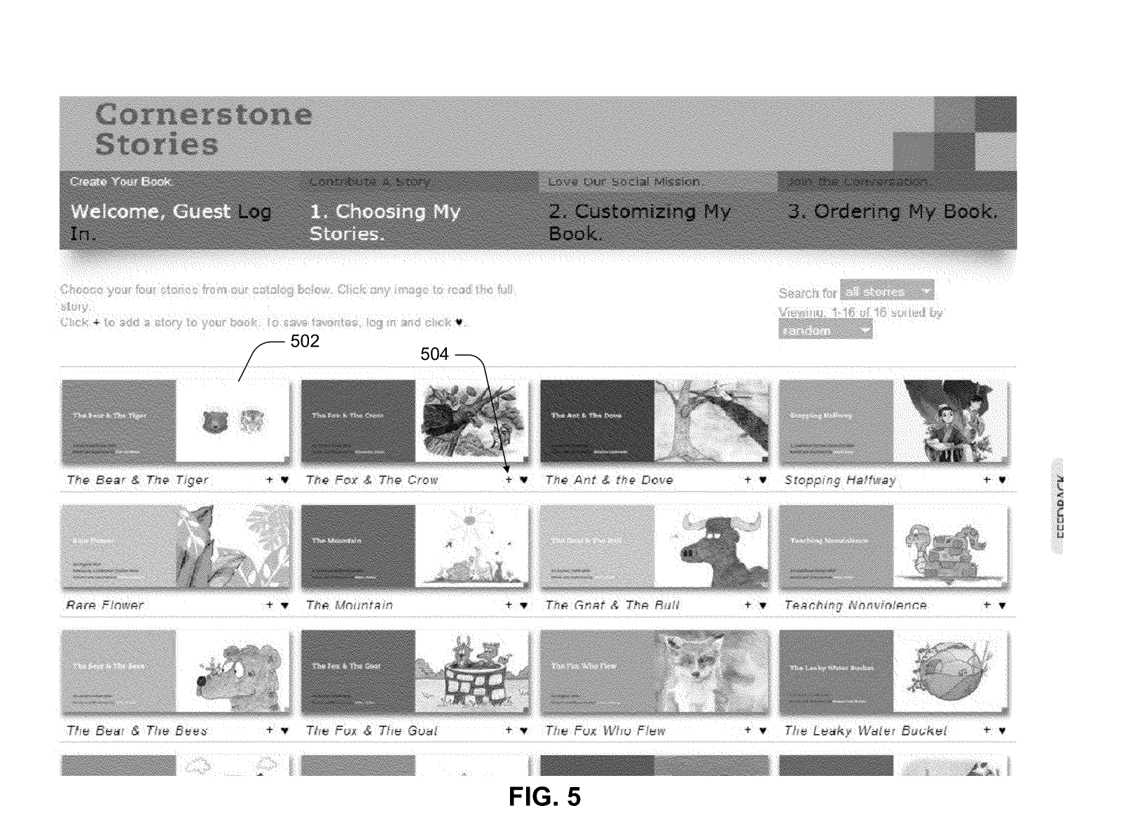

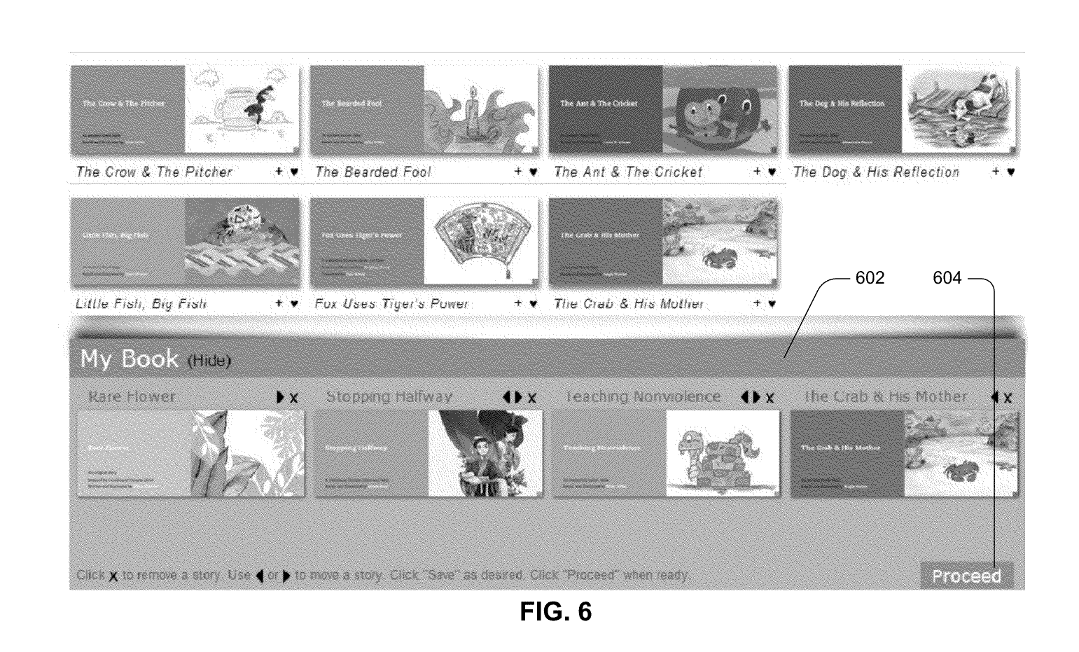

Referring now to FIG. 5, users may create an account and log in or proceed as a guest. On a “Choosing My Stories” page, users may choose a configurable number of stories for their custom storybook. Stories may be previewed by clicking on a thumbnail 502 of each available story, and add the story, if desired, to their storybook. Stories may be searched or viewed randomly. Users may click an ‘add’ indicator 504 to add the story to their custom storybook. FIG. 6 illustrates the story page with a window showing the stories chosen by the user 602. When all stories have been chosen, the user may click a “proceed” button 604 to continue with the ordering process.

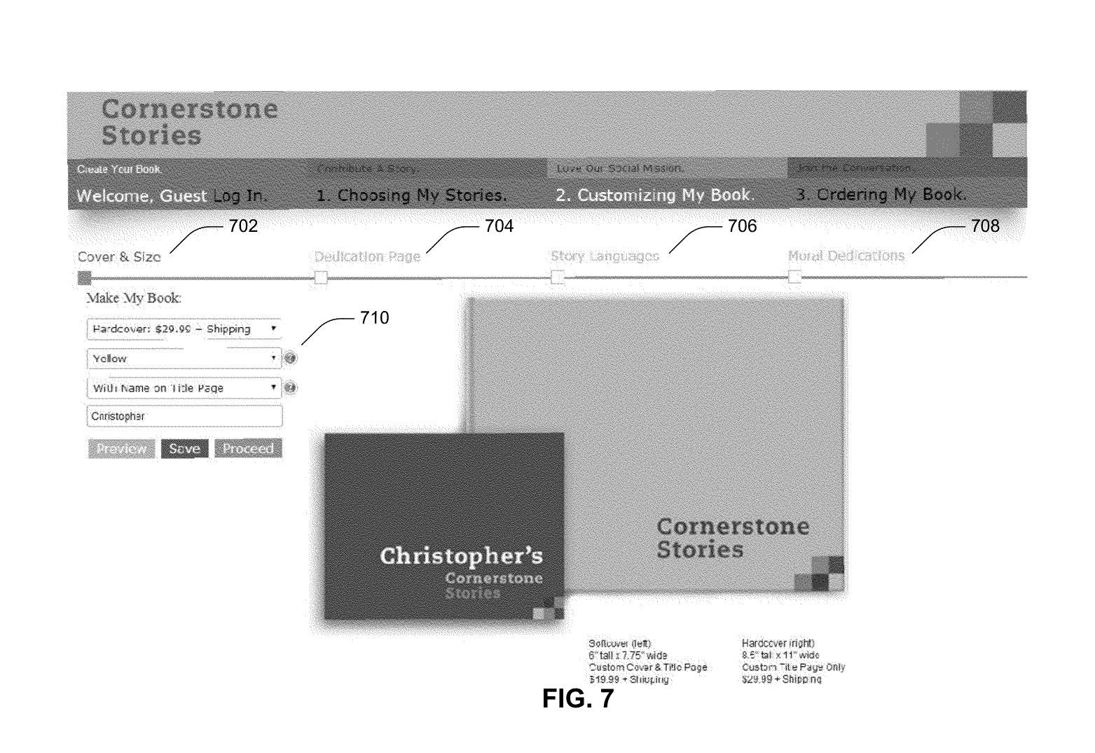

FIG. 7 illustrates a customization page for a custom storybook interface. Customizing the book involves selecting elements such as, by way of example and not limitation, the cover and size of the book 702, defining what, if any, dedication message is desired on the dedication page 704, what language 706 in which they wish the stories to be presented, and any moral dedications 708 desired. In selecting cover and size, the user may select whether they would like a hard or softcover book, the color of the book, whether they would like the name on the title page, and what that name will be. Customers may preview their custom storybook and save and proceed with customization.

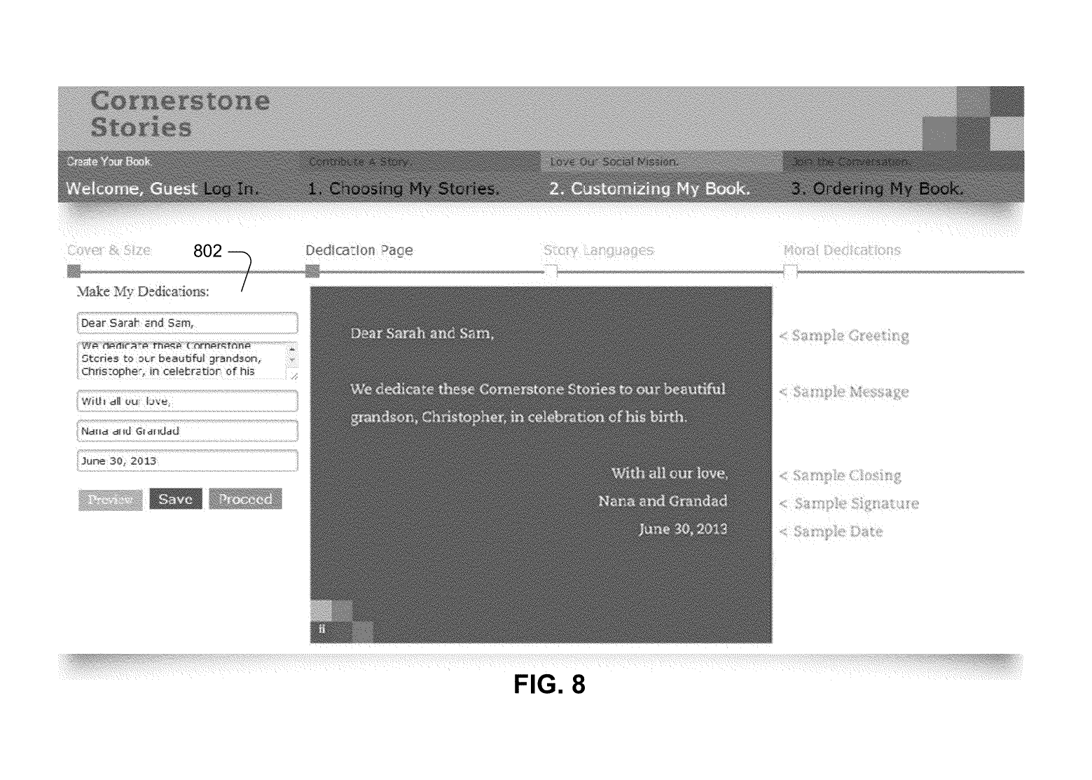

FIG. 8 illustrates a dedication page 802 where the customer may write a personalized dedication or note to the recipient of the book, including a greeting, a message, a closing, signature and date, or other such information.

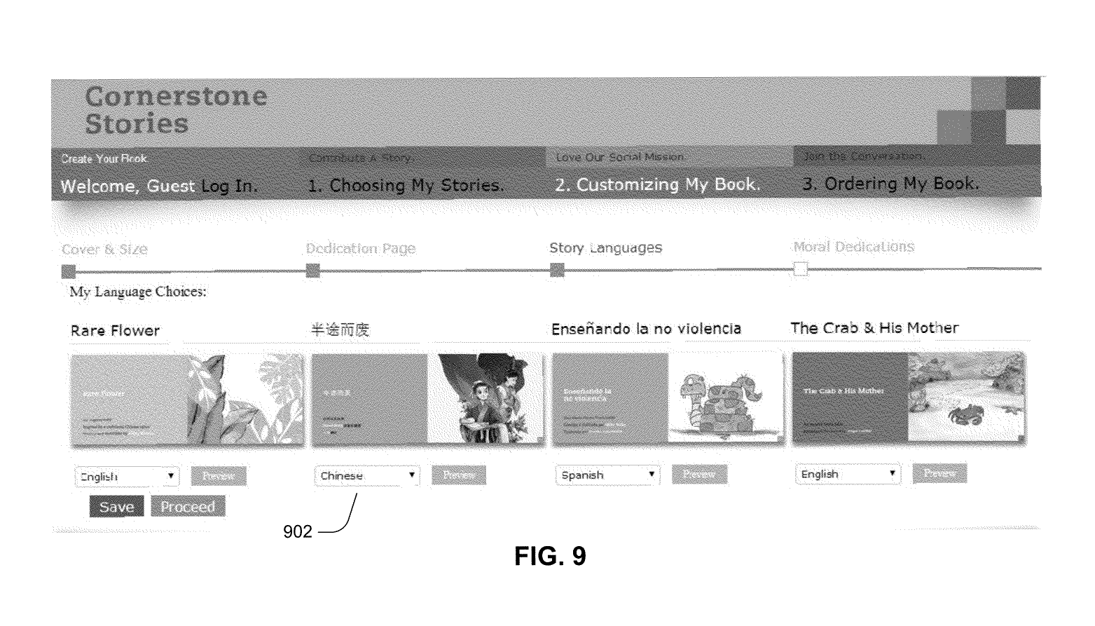

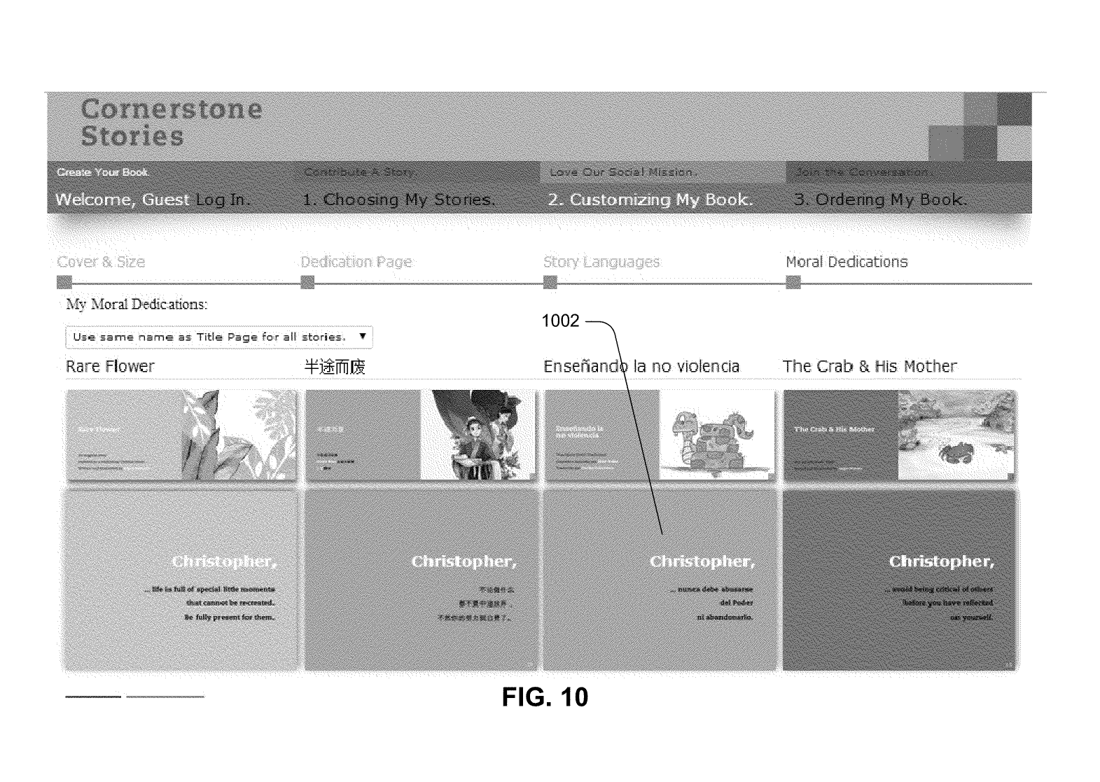

In FIG. 9, a screen shot illustrates choosing a particular language 902 for each of the stories. Stories may be presented in the same language throughout the book, or a different language for any of the stories. The moral dedications interface illustrated in FIG. 10, allows users to personalize the moral of the story 1002 with the recipient's name on the “moral dedications” page.

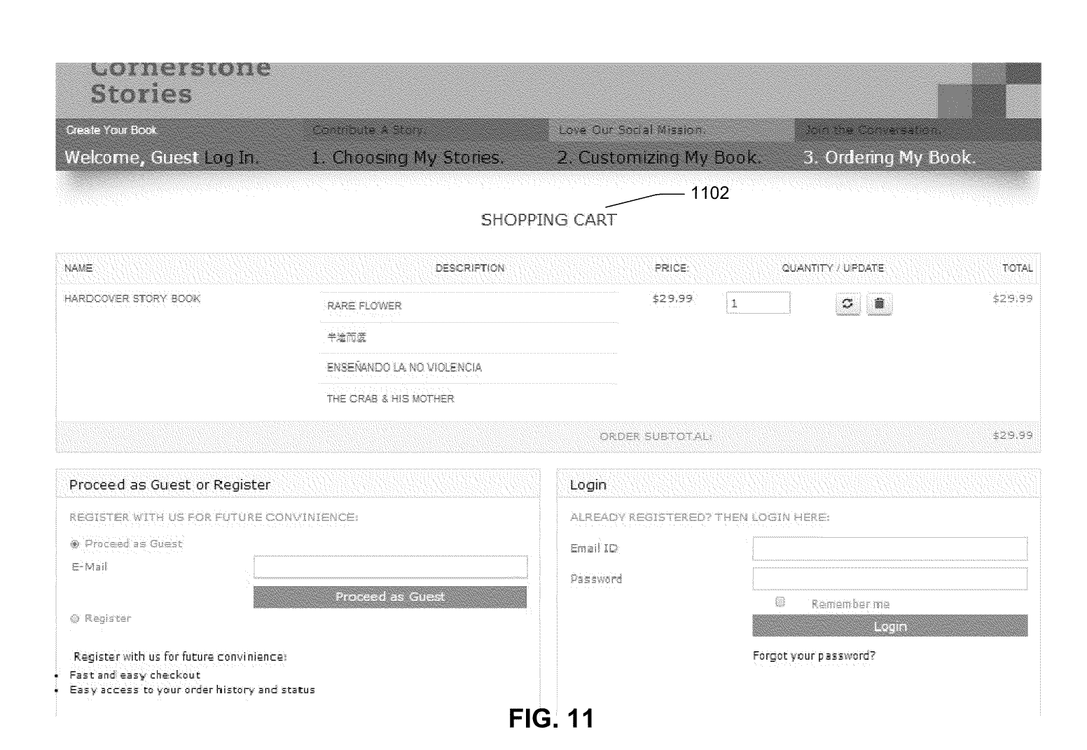

In FIG. 11, the “ordering my book” page presents the shopping cart 1102 where users may complete their purchase.

The above Detailed Description includes references to the accompanying drawings, which form a part of the Detailed Description. The drawings show, by way of illustration, specific embodiments in which the present customized storybooks and related methods can be practiced. These embodiments are also referred to herein as “examples.”

The above Detailed Description is intended to be illustrative, and not restrictive. For example, the above-described examples (or one or more elements thereof) can be used in combination with each other. Other embodiments can be used, such as by one of ordinary skill in the art upon reviewing the above description. Also, various features or elements can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

In this document, the terms “a” or “an” are used to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated.

In the appended claims, the terms “including” and “in which” are used as the plain-English equivalents of the respective terms “comprising” and “wherein.” Also, in the following claims, the terms “including” and “comprising” are open-ended, that is, an assembly, kit, or method that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

What is claimed is:

1. A method for providing customized storybooks over a network such as the internet, comprising:
presenting a list of stories to a plurality of artists;
providing the plurality of artists with a common design parameter;
providing each artist with instructions to submit at least one version of his/her story; and
executing a license agreement with each artist submitting a story version, thereby allowing his/her at least one story version to be selected and published.

2. The method of claim 1, wherein presenting the list of stories includes presenting stories already in the public domain or original stories that have been submitted by an author for retelling and illustration.

3. The method of claim 1, wherein providing the plurality of artists with the common design parameter includes providing one or more of a set number of pages per story, a set size for an image, a locked aspect ratio for the image, directions on type of materials to be used, instructions for positioning text within a story, and a set target age level for the story.

4. The method of claim 2, wherein providing the plurality of artists with the common design parameter includes providing one or more of a set number of pages per story, a set size for an image, a locked aspect ratio for the image, directions on type of materials to be used, instructions for positioning text within a story, and a set target age level for the story.

5. The method of claim 1, further comprising providing a mechanism for each artist to submit and receive feedback on his/her at least one story version.

6. A method for providing customized storybooks over a network such as the internet, comprising:
allowing a customer to select more than one story, from a catalog with a plurality of short stories;
allowing the customer to select the order of the more than one story within a single storybook; and
allowing the customer to select at least one language for each story selected.

7. The method of claim 6, wherein allowing the customer to select more than one story includes allowing a customer to select more than one story with a consistent design parameter.

8. The method of claim 7, further comprising allowing the customer to provide variable text information for at least one story selected.

9. The method of claim 6, further comprising allowing the customer to provide variable text information for at least one story selected.

10. The method of claim 6, further comprising allowing the customer to customize one or both of a cover page and a dedication page of the storybook.

11. The method of claim 6, further comprising having a publishing company arrange the customer's unique order information and create an original digital file for the storybook.

12. The method of claim 11, further comprising printing, binding, and shipping of the story book.

13. A computer-readable non-transitory media stored thereon computer executable instructions, wherein the instructions perform steps for allowing a user to create a customized storybook online, comprising:
providing a user interface to choose stories and customization features for the storybook,
wherein such features include at least one of (1) language, (2) dedication messages, and (3) identification of the recipient;
wherein such features include the appearance and cover type of the book; and
providing a shopping cart interface.
